(19) United States
(12) Patent Application Publication
(10) Pub. No.: US 2009/0267789 A1
(43) Pub. Date: Oct. 29, 2009

(54) Socket Structure with a Remote Control Switch

(76) Inventor: Hui-Nan Lin, Kaohsiung City (TW)

Correspondence Address: Dr. BANGER SHIA, 102 Lindencrest Ct., Sugar Land, TX, 77479-5201, US

(21) Appl. No.: 12/109,241

(22) Filed: Apr. 24, 2008

(51) Int. Cl. G08B 5/22; G08C 19/00

(52) U.S. Cl. 340/825.36; 340/825.72

(57) ABSTRACT

A socket structure with a remote control switch comprises a control switch and a power-supplying seat. The power-supplying seat is provided with an indication light source, and the control switch is turned on or off by a direct driving means. Thereby, the control switch is less likely to cause an invalid operation or change its operating direction, and makes the user clearly and easily tell if the power-supplying seat is turned on or off.

### BACKGROUND OF THE INVENTION

1. Field of the Invention

The present invention relates to a socket structure, and more particularly to a socket structure with a remote control switch which makes the user clearly and easily tell if a power-supplying seat is turned on or off.

2. Description of the Prior Art

Currently, the use of various kinds of electrical appliances and electronic devices has become indispensable to people's daily life. However, not only the electrical appliances and the electronic devices themselves need power source, but also they should be maintained in electrical connection with the power source even during standby. As a result, it will waste power while shortening the life of the electrical appliances and the electronic devices.

Further, other than lamps and household electrical appliances with a remote control function, the ordinary electrical appliances which are plugged in the socket and without the remote control function, such as table lamp, fan, warm stove, conventional electric cooker, all have to be maintained in electrical connection with the power source all the time. Therefore, such electrical appliances also have the above-mentioned problem of energy consumption and are inconvenient to operate.

To solve the above-mentioned problems, a conventional socket structure 10 with a wireless remote control switch appeared in the market as shown in FIGS. 1 and 2, the connection and disconnection of such a socket structure 10 is controlled by a control rod 12 of a wireless remote 11, and the electrical appliance or equipment plugged in the socket structure 10 can be connected or disconnected by the wireless remote 11 at any time. The control rod 12 of such a wireless remote 11 utilizes a guiding post 121 to move a spring 122 and a steel ball 123, and the steel ball 123 can be forced by the spring 122 to roll over a ramp 124 and selectively into one of the proximity grooves 125 defined at both sides of the ramp 124, thus achieving the function of controlling the connection or disconnection of the socket structure 10. Such a conventional socket structure 10 is convenient to control and can save energy, but it still has the following disadvantages that need to be solved:

Firstly, since the connection or disconnection of such a socket structure 10 is controlled by the control rod 12 of the wireless remote 11, with naked eyes, the user can tell if the electrical appliance or equipment is connected or disconnected, but in case of a failure of the electrical appliance or equipment, the user cannot tell if it is connected or disconnected, which will cause energy consumption and potential danger.

Secondly, the control rod 12 of such a wireless remote 11 utilizes the steel ball 123 which is selectively rolled into one of the proximity grooves 125 defined at both sides of the ramp 124 to achieve the function of controlling the connection or disconnection of the socket structure 10. However, since the steel ball 123 rolled over the ramp 124 must be positioned by the spring 122, when the user turns the control rod 12 too many times (cause spring fatigue) or too fast, the steel ball 123 is likely to be disengaged from the spring 122. Although the user can pull the control rod 12 again to reposition the steel ball 123 with the spring 122, the turning on and off directions will be exchanged, for example, the operation of turning left means turning off previously, but now it will effect the function of turning on. And the user can only tell if the electrical appliance or equipment is connected or disconnected with naked eyes. As a result, the operation accuracy is reduced, which will cause an invalid operation or change the operating direction of the wireless remote 11.

To solve the above-mentioned problems, the present invention provides a brand new socket structure with a remote control switch which has a simplified structure and a low cost.

### SUMMARY OF THE INVENTION

The primary objective of the present invention is to provide a socket structure with a remote control switch which makes the user easily tell if a power-supplying seat is turned on or off.

To achieve the above objective, the present invention provides a socket structure with a remote control switch which comprises a control switch and a power-supplying seat. The power-supplying seat is provided with an indication light source, and the control switch which controls the power-supplying seat will affect the on and off of the indication light source.

The above-mentioned indication light source comprises a light emitting diode (LED) assembled in the power-supplying seat and a light guide piece assembled on a surface of the power-supplying seat.

Thereby, the user can know the status (on or off) of the power from the on or off state of the indication light source, and can clearly and easily tell if the power-supplying seat is turned on or off.

It is to be noted that the above-mentioned indication light source is the light emitting diode (LED) assembled in a circuit of the power-supplying seat, and on the surface of the power-supplying seat is provided transparent material corresponding to the indication light source.

In addition, the power-supplying seat can be designed in two forms: one is power supply socket, the other is the power-supplying seat with a hidden power source.

The second objective of the present invention is to provide a socket structure with a remote control switch which is less likely to cause an invalid operation or change the operating direction of the control switch.

To achieve the above objective, the control switch of the present invention is turned on or off by a direct driving means, such that the control switch is less likely to cause an invalid operation or change its operating direction.

What follows are two examples of direct driving means: A, utilizing an elastic driving rod to directly drive a sensing piece to move, and the movement of the sensing piece is used to control the connection and disconnection of the power-supplying seat;

B, cooperating with two proximity sensors and the elastic driving rod to swing a fin disposed at an upper position of the driving rod, so as to directly press one of the proximity sensors for controlling the connection and disconnection of the power-supplying seat.

Moreover, the present invention takes two direct driving means as example, and the number, position and elastic mode of the related components are of conventional techniques and will not be described in detail.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional socket structure with a wireless remote control switch;

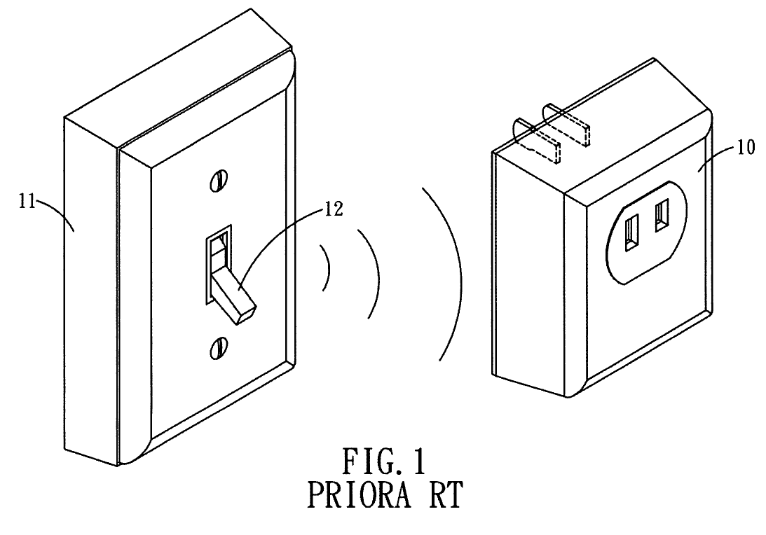

FIG. 2 is a partial cross sectional view of the conventional socket structure with a wireless remote control switch;

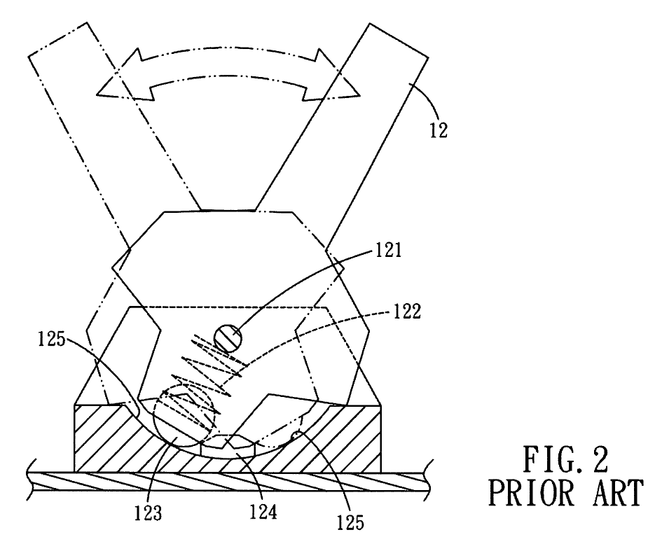

FIG. 3 is a perspective view of a socket structure with a remote control switch in accordance with a first embodiment of the present invention;

FIG. 4 is an illustrative view showing the socket structure with a remote control switch in accordance with the first embodiment of the present invention;

FIG. 5 is an exploded view of the socket structure with a remote control switch in accordance with the first embodiment of the present invention;

FIG. 6 is a perspective view of a socket structure with a remote control switch in accordance with a second embodiment of the present invention;

FIG. 7 is an illustrative view showing the socket structure with a remote control switch in accordance with the second embodiment of the present invention;

FIG. 8 is an exploded view of the socket structure with a remote control switch in accordance with the second embodiment of the present invention;

FIG. 9 is an exploded view of the socket structure with a remote control switch in accordance with a third embodiment of the present invention;

FIG. 10 is an exploded view of the socket structure with a remote control switch in accordance with a fourth embodiment of the present invention; and

FIG. 11 is an exploded view of another embodiment of a power-supplying seat in accordance with the present invention.

### DETAILED DESCRIPTION OF THE PREFERRED EMBODIMENTS

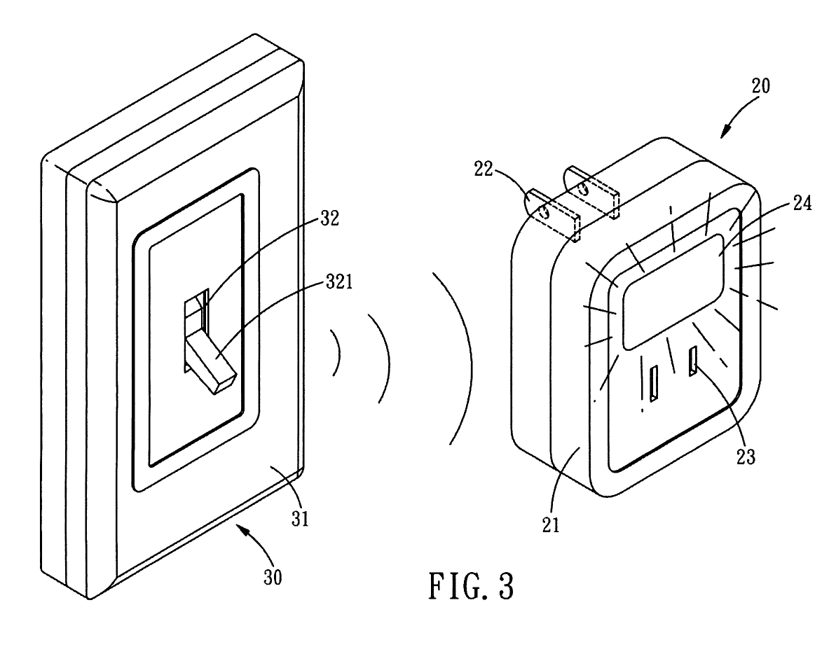

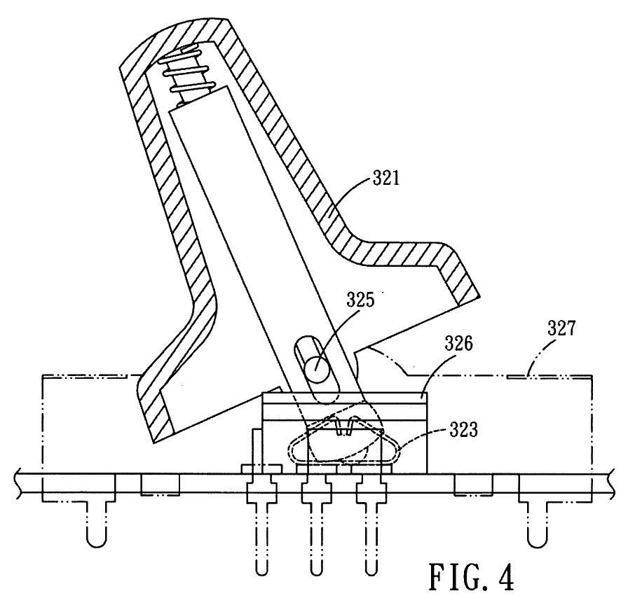

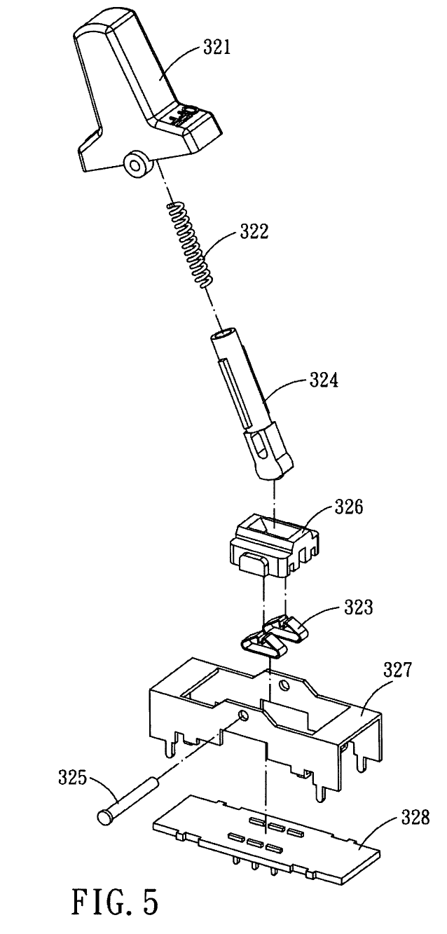

Referring to FIGS. 3-5, a socket structure with a remote control switch in accordance with a first embodiment of the present invention comprises a power-supplying seat 20 and a control switch 30 which are wirelessly connected.

The power-supplying seat 20 comprises a body 21, at least two inserting rods 22, at least two inserting holes 23 and an indication light source 24. The inserting rods 22 and the inserting holes 23 are fixed at the opposite sides of the body 21. The indication light source 24 is assembled to the body 21 for emitting light toward outside.

The control switch 30 comprises a housing 31 and at least one control assembly 32. The control assembly 32 is assembled to the housing 31, and a driving rod 321 having a spring 322 is disposed in the control assembly 32 and directly drives a plurality of sensing pieces 323 to move, and the movement of the sensing pieces 323 is used to produce different signals for controlling the connection and disconnection between the inserting rods 22 and the inserting holes 23 of the power-supplying seat 20. Meanwhile, the indication light source 24 of the power-supplying seat 20 turns on at the time the inserting rods 22 and the inserting holes 23 are connected and turn off at the time the inserting rods 22 and the inserting holes 23 are disconnected.

With the above-mentioned structures, the control switch 30 of the present invention utilizes the control assembly 32 to directly drive the sensing pieces 323 to move, and the movement of the sensing pieces 323 is used to produce different signals for controlling the connection and disconnection of the power-supplying seat 20, so as to turn on and off the indication light source 24, such that the user can clearly and easily tell if the power-supplying seat 20 is turned on or off.

Further, since the present invention utilizes the direct driving means to drive the sensing pieces 323 to move, the movement of the sensing pieces 323 will not cause an invalid operation or change the operating direction of the sensing pieces 323.

It is to be noted that the driving rod 321 of the control switch 30 is pivotally disposed in a positioning member 327 together with a guiding rod 324 and a bolt 325. The guiding rod 324 is axially assembled to the driving rod 321 and is mounted with the spring 322. The guiding rod 324 cooperates with the spring 322 to push against a sliding block 326. The sensing pieces 323 are positioned on a bottom of the sliding block 326 and are located corresponding to a signal member 328 having sensing points. The user can pull the driving rod 321 back and forth to move the sensing pieces 323, and the movement of the sensing pieces 323 is used to change the positions at which the sensing pieces 323 contact the signal member 328.

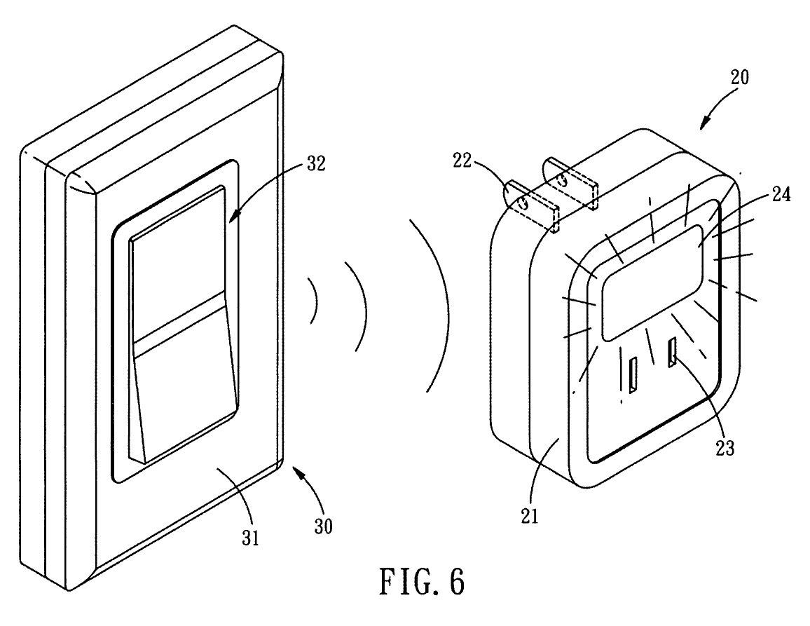

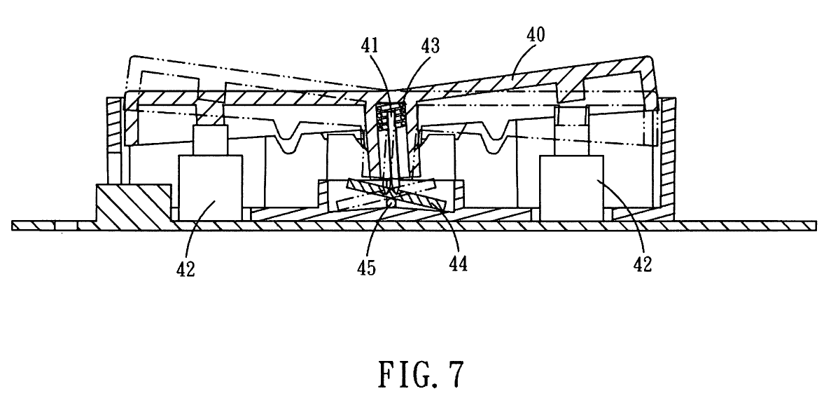

Referring to FIGS. 6-8, a socket structure with a remote control switch in accordance with a second embodiment of the present invention is shown, the above-mentioned embodiment has clearly described the structure of the indication light source 24, and this embodiment describes another direct driving means:

The socket structure with a remote control switch in accordance with the second embodiment of the present invention comprises the power-supplying seat 20 and the control switch 30 which are wirelessly connected.

The power-supplying seat 20 comprises the body 21, at least two inserting rods 22, at least two inserting holes 23 and the indication light source 24. The inserting rods 22 and the inserting holes 23 are fixed at the opposite sides of the body 21. The indication light source 24 is assembled to the body 21 for emitting light toward outside.

The control switch 30 comprises the housing 31 and at least one control assembly 32. The control assembly 32 is assembled to the housing 31 and comprises a fin 40, an elastic driving rod 41 and two proximity sensors 42. The proximity sensors 42 are assembled to a signal member 47, and the signal member 47 is assembled in the housing 31 together with a circuit design. The fin 40 is assembled to a positioning member 46 by a swing means. The driving rod 41 is positioned on a bottom of the fin 40 after being mounted with a spring 43, and a sliding shaft 45 and a sliding piece 44 disposed on the sliding shaft 45 are assembled on a bottom of the positioning member 46. A bottom of the driving rod 41 is abutted against the sliding piece 44, and the driving rod 41 uses the elasticity and cooperates with the sliding piece 44 to swing the fin 40, so as to directly press one of the proximity sensors 42, thus turning on or off the power-supplying seat 20.

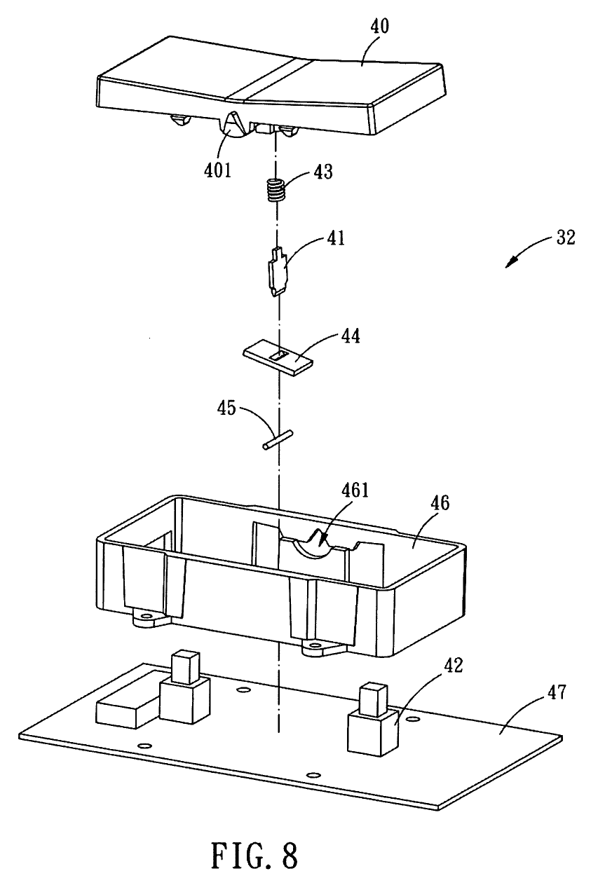

The above-mentioned swing means is shown in FIG. 8: both sides of the fin 40 are provided with a protrusion 401, and both side surfaces of the positioning member 46 are defined with a fan-shaped space 461 in which the protrusion 401 is received, which allows the fin 40 and the positioning member 46 to swing within a predetermined angle.

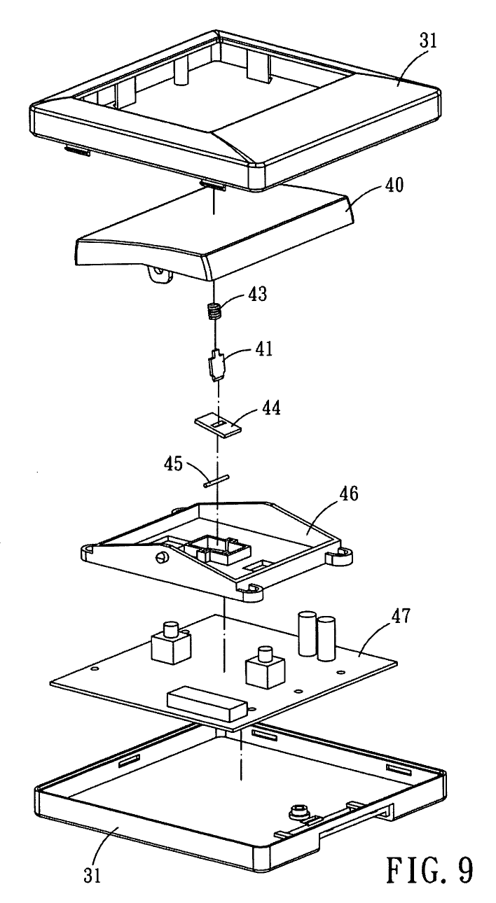

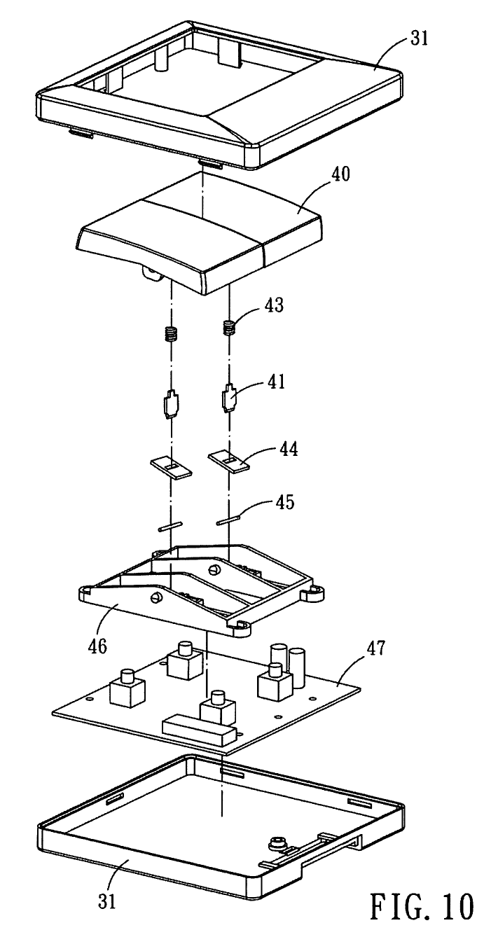

Referring to FIGS. 9 and 10, a socket structure with a remote control switch in accordance with a third and fourth embodiment of the present invention are shown, the two embodiments all use the above-mentioned fin 40, spring 43, driving rod 41, sliding shaft 45, sliding piece 44 and proximity sensors 42, and the positioning member 46 of the two embodiments is positioned in the housing 31 of the control switch 30 together with the signal member 47. The only difference between the two embodiments is that the fin 40 of the first is different in shape, size and number from that of the second, and all such modifications are also within the scope of the present invention.

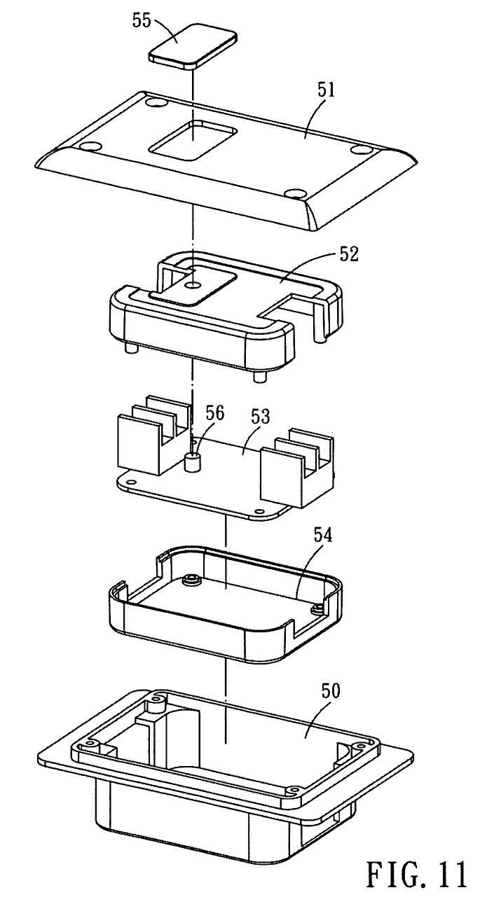

Referring to FIG. 11, which shows another embodiment of the power-supplying seat 20 in addition to the form of socket. The power-supplying seat 20 comprises a body 50, an upper cover 51, a receiving cover 52, a circuit board 53, a receiving seat 54 and an indication light source. The indication light source comprises a light guide piece 55 and a light source 56. The above-mentioned components all assembled in the assembled body 50 and the upper cover 51. The light source 56 is positioned on the circuit board 53 and emits light toward the light guide piece 55, and the receiving cover 52 cooperates with the receiving seat 54 to wrap the circuit board 53, so as to improve the signal-receiving effect. In addition, the power-supplying seat 20 of the present embodiment can be controlled by a control switch to turn on or off the light source 56 at the time the circuit is connected or disconnected.

To summarize, the socket structure with a remote control switch of the present invention comprises a control switch and a power-supplying seat. The power-supplying seat is provided with an indication light source, and the control switch is turned on or off by a direct driving means.

Thereby, the control switch is less likely to cause an invalid operation or change its operating direction, and makes the user clearly and easily tell if the power-supplying seat is turned on or off.

While we have shown and described various embodiments in accordance with the present invention, it should be clear to those skilled in the art that further embodiments may be made without departing from the scope of the present invention.

What is claimed is:

1. A socket structure with a remote control switch, comprising: at least one control switch and one power-supplying seat, wherein:
the power-supplying seat is provided with an indication light source;
the control switch is wirelessly connected to the power-supplying seat for controlling a circuit of the power-supplying seat, and the on and off of the indication light source of the power-supplying seat is associated with the change of state of the power-supplying seat.

2. The socket structure with a remote control switch as claimed in claim 1, wherein the indication light source comprises at least one light emitting diode assembled in the power-supplying seat and at least one light guide piece assembled on a surface of the power-supplying seat.

3. The socket structure with a remote control switch as claimed in claim 1, wherein the circuit is disposed in the power-supplying seat, and the connection and disconnection of the circuit of the power-supplying seat is controlled by the control switch.

4. A socket structure with a remote control switch, comprising: at least one power-supplying seat and one control switch which are wirelessly connected, wherein:
the power-supplying seat comprises a body, at least two inserting rods, at least two inserting holes and an indication light source, the inserting rods and the inserting holes are fixed at opposite sides of the body, the indication light source is assembled to the body for emitting light toward outside;
the control switch comprises a housing and at least one control assembly, the control assembly is assembled to the housing, a driving rod having a spring is disposed in the control assembly and directly drives a plurality of sensing pieces to move, the movement of the sensing pieces is used to produce different signals for controlling the connection and disconnection between the inserting rods and the inserting holes of the power-supplying seat, meanwhile, the indication light source of the power-supplying seat turns on at the time the inserting rods and the inserting holes are connected and turns off at the time the inserting rods and the inserting holes are disconnected.

5. The socket structure with a remote control switch as claimed in claim 4, wherein the indication light source comprises a light emitting diode (LED) assembled in the power-supplying seat and a light guide piece assembled on a surface of the power-supplying seat.

6. The socket structure with a remote control switch as claimed in claim 4, wherein the driving rod of the control switch is pivotally disposed in a positioning member together with a guiding rod and a bolt, the guiding rod is axially assembled to the driving rod, the spring is mounted on the guiding rod, the guiding rod cooperates with the spring to push against a sliding block, the sensing pieces are positioned on a bottom of the sliding block and are located corresponding to a signal member having sensing points, the driving rod is driven back and forth to move the sensing pieces, and the movement of the sensing pieces is used to change positions at which the sensing pieces contact the signal member.

7. A socket structure with a remote control switch, comprising: at least one power-supplying seat and one control switch which are wirelessly connected, wherein:
the power-supplying seat comprises a body, at least two inserting rods, at least two inserting holes and an indication light source, the inserting rods and the inserting holes are fixed at opposite sides of the body, the indication light source is assembled to the body for emitting light toward outside;
the control switch comprises a housing and at least one control assembly, the control assembly comprises a fin, an elastic driving rod and two proximity sensors, the proximity sensors are assembled on a signal member, the signal member is assembled in the housing together with a circuit design, the fin is assembled to a positioning member by a swing means, the driving rod is positioned on a bottom of the fin after being mounted with a spring, a sliding shaft and a sliding piece disposed on the sliding shaft are assembled on a bottom of the positioning member, a bottom of the driving rod is abutted against the sliding piece, the driving rod uses the elasticity and cooperates with the sliding piece to swing the fin, so as to directly press one of the proximity sensors of the control assembly to produce different signals for controlling the connection and disconnection between the inserting rods and the inserting holes of the power-supplying seat, meanwhile, the indication light source of the power-supplying seat turns on at the time the inserting rods and the inserting holes are connected and turns off at the time the inserting rods and the inserting holes are disconnected.

8. The socket structure with a remote control switch as claimed in claim 7, wherein the indication light source comprises a light emitting diode (LED) assembled in the power-supplying seat and a light guide piece assembled on a surface of the power-supplying seat.

9. The socket structure with a remote control switch as claimed in claim 7, wherein a protrusion is disposed at both sides of the fin of the control assembly, respectively, and a fan-shaped space for accommodation of the protrusion is defined in both side surfaces of the positioning member, so that the fin of the control assembly and the positioning member is allowed to swing within a predetermined angle.
